(19) United States
(12) Patent Application Publication
(10) Pub. No.: US 2010/0191715 A1
(43) Pub. Date: Jul. 29, 2010

(54) Computer Implemented System for Providing Musical Message Content

(76) Inventor: Shefali Kumar, New York, NY (US)

Correspondence Address: Russ Weinzimmer, 614 Nashua Street, Suite 53, Milford, NH, 03055, US

(21) Appl. No.: 12/362,255

(22) Filed: Jan. 29, 2009

(51) Int. Cl. G06F 7/06; G06F 15/16; G06F 17/30

(52) U.S. Cl. 707/708; 707/E17.016; 707/E17.008; 707/E17.014; 707/E17.046

(57) ABSTRACT

A computer-implemented system is disclosed for providing musical message content. The system can accept a request specifying at least one musical theme and a destination email address or telephone number. The system then selects at least one appropriate musical recording from a database of musical recordings associated with themes, and provides a selected musical recording to the designated destination. The requesting and/or receiving devices can be telephones, cell phones, smart phones, PDA's, email-enabled devices, and/or web-enabled devices. Thematic categories can relate to emotions, relationships, special occasions, occupations, religions, and music. A message and/or picture and/or video can be delivered with the musical recording, and user interfaces can facilitate selection of any or all message elements, including selection of a musical recording from a group of candidate recordings associated with the specified theme or themes. In some embodiments, user-submitted musical recordings can be added to the database.

### FIELD OF THE INVENTION

The invention generally relates to creating and delivering messages, and more specifically to creating and delivering messages having an audio component.

### BACKGROUND OF THE INVENTION

Most communication is accomplished using words. However, words are often inadequate, or at least inefficient, for communicating emotional content. When communicating in person, facial expressions often convey emotional nuances that are not well communicated by words alone. However, when sending a message to someone, it is usually not possible to include facial expressions, except perhaps in the limited form of so-called “emoticons.”

Vocal inflection can also be used to enhance the emotional content of a message, for example in a telephone message or a recorded voice message attached to an email. However, the sender of a message may not feel that voice inflection is a desirable or sufficient means to convey emotions and feelings, especially when they are personal and/or strongly felt.

One of the most powerful means for communicating emotional content is through music. For this reason, most movies and television shows make liberal use of music so as to increase the emotional impact of the entertainment provided and increase the emotional involvement of viewers. Small devices that automatically play musical selections are even included with some greeting cards.

Musical recordings can be transmitted as messages, for example by telephone, or they may be attached to text-based messages such as emails and telephone “SMS” text messages. Services are available that assist customers in attaching musical selections of their choosing to email and other messages. However, this approach places on the message originator the most or all of the burden of choosing and preparing the musical selection. Services are also available that will compose and create custom musical recordings for attachment to messages, but of course this is highly labor intensive and therefore highly costly.

Electronic greeting cards that include musical recordings are well known. So as to facilitate selection of the most appropriate message, electronic greeting cards are often organized according to emotional themes, such as “I'm sorry” or “love;” relationships such as “friend,” “daughter,” or “mom;” or special occasions such as “birthday,” anniversary,” and such like. However, when sending an electronic greeting card, a message originator must usually select a card that includes a visual and musical combination from among a limited selection of such cards. Also, electronic greeting cards are not well suited to telephone messages or to text messaging.

### SUMMARY OF THE INVENTION

A computer implemented system is claimed that can accept a request for a musical recording associated with at least one specified thematic category, select an appropriate musical recording from a database containing a plurality of musical recordings associated with various thematic categories, and provide the selected musical recording to a receiver designated in the request. The requesting and/or the receiving device can be a computer, a telephone, a personal digital assistant, a smart phone, a device that is able to send text messages; and/or a device that is able to browse the internet. Thematic categories can relate to emotions, relationships, special occasions, occupations, religions, and music, and such like.

In preferred embodiments, the invention is able to deliver a message cooperative with the musical recording, and can provide a user interface that is able to facilitate specification of the message. If the database contains more than one candidate musical selection pertaining to the specified thematic category or categories, a user interface can be provided to facilitate selection of one of the candidate musical recordings, or one of the musical recordings can be chosen at random by the computer. In further preferred embodiments, user submitted musical recordings can be added to the database.

One general aspect of the present invention is an article of manufacture for providing musical message content. The article of manufacture includes media containing software that is able to direct the actions of a computer so as to cause the computer to accept a request from a requesting source, the request specifying at least one thematic category and a receiving destination, the at least one thematic category being selected from a group of selectable thematic categories. The software is further able to direct the actions of the computer so as to cause the computer to select from a database a musical recording associated with the specified at least one thematic category, the database containing a plurality of musical recordings, each musical recording being associated with at least one of the selectable thematic categories. In addition, the software is able to direct the actions of the computer so as to cause the computer to provide the selected musical recording to the specified receiving destination.

In preferred embodiments, the requesting source is a computer, a telephone, a personal digital assistant, a smart phone, a device that is able to send text messages, and/or a device that is able to browse the internet.

In other preferred embodiments, the receiving destination is a computer, a telephone, a personal digital assistant, a smart phone, a device that is able to send text messages, and/or a device that is able to browse the internet.

In certain preferred embodiments, accepting the request and/or providing the musical recording includes communication using wired telephony, wireless telephony, network communication, and/or communication over the internet.

In various preferred embodiments, the invention further includes media containing the database containing a plurality of musical recordings associated with selectable thematic categories.

In some preferred embodiments, the software is able to cause the computer to accept input from the requesting device specifying a message to be sent to the receiving device in cooperation with the musical recording. In some of these embodiments, the message includes text, a visual image, and/or a visual animation. And in other of these embodiments the software is able to cause the computer to provide a user interface that can facilitate specification of the message.

In preferred embodiments, the software is able to cause the computer to provide a user interface that can facilitate selection of the musical recording from a group of candidate musical recordings that are associated with the specified at least one thematic category.

In some preferred embodiments, when a plurality of musical recordings in the database is associated with the at least one thematic category, the software is able to cause the computer to randomly select one musical recording from among the plurality of musical recordings, and to provide it to the specified receiving destination.

In various preferred embodiments the group of selectable thematic categories includes a category relating to emotions, relationships, special occasions, occupations, religions, and/or music.

In certain preferred embodiments, the software is able to cause the computer to accept from a user a musical recording associated with at least one of the selectable thematic categories, and to add the accepted musical recording to the database. And in some of these embodiments the user can specify that the accepted musical recording added to the database will either be only available for selection by the user, or generally available for selection by all users.

Another general aspect of the present invention is an apparatus for providing musical message content. The apparatus includes a computer having access to a database of musical recordings, each musical recording being associated with at least one of a group of selectable thematic categories. The computer is able to accept a request from a requesting source, the request specifying at least one thematic category and a receiving destination, the at least one thematic category being selected from the group of selectable thematic categories, select from the database a musical recording associated with the specified at least one thematic category, and provide the selected musical recording to the specified receiving destination.

In preferred embodiments, the requesting source and/or the receiving destination is a computer, a telephone, a personal digital assistant, a smart phone, a device that is able to send text messages, and/or a device that is able to browse the internet. In some preferred embodiments, the database containing a plurality of musical recordings is resident on the computer.

In various preferred embodiments, the computer is able to accept input from the requesting device specifying a message to be sent to the receiving device in cooperation with the musical recording. In some of these preferred embodiments the message includes text, a visual image, and/or a visual animation.

In certain preferred embodiments, the computer is able to provide a user interface that can facilitate selection of the musical recording from a group of candidate musical recordings that are associated with the specified at least one thematic category.

In other preferred embodiments, the group of selectable thematic categories includes a category relating to emotions, relationships, special occasions, occupations, religions, and/or music.

And in some preferred embodiments the computer is able to accept from a user a musical recording associated with at least one of the selectable thematic categories, and add the accepted musical recording to the database.

### BRIEF DESCRIPTION OF THE DRAWINGS

The invention will be more fully understood by reference to the detailed description, in conjunction with the following figures, wherein:

FIG. 1A is a block diagram illustrating the elements of the present invention and their cooperative interaction in a basic embodiment;

FIG. 1B is an illustration of a specific embodiment in which the requesting source is a personal computer that submits a request over the internet and the receiving destination is a cellular telephone that receives the musical recording by wireless telephony;

FIG. 2A is an illustration of a preferred embodiment user interface display screen inviting a user to originate a request for sending of a musical recording;

FIG. 2B is an illustration of a preferred embodiment user interface display screen inviting a user to select a theme for a musical recording;

FIG. 2C is an illustration of a preferred embodiment user interface display screen inviting a user to select a musical recording;

FIG. 2D is an illustration of a preferred embodiment user interface display screen inviting a user to review the details of a selected musical recording and to preview the musical recording;

FIG. 2E is an illustration of a preferred embodiment user interface display screen inviting a user to compose a text message to accompany the selected musical recording;

FIG. 2F is an illustration of a preferred embodiment user interface display screen inviting a user to upload a picture or a video clip to accompany the selected musical recording;

FIG. 2G is an illustration of a preferred embodiment user interface display screen inviting a user to specify at least one recipient for the selected musical recording; and

FIG. 2H is an illustration of a preferred embodiment user interface display screen inviting a user to upload a musical recording to be added to either a private or public section of the database of musical recordings.

### DETAILED DESCRIPTION OF PREFERRED EMBODIMENTS

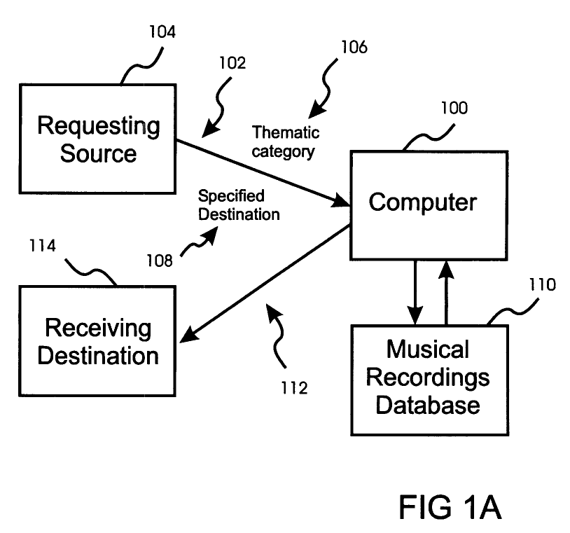

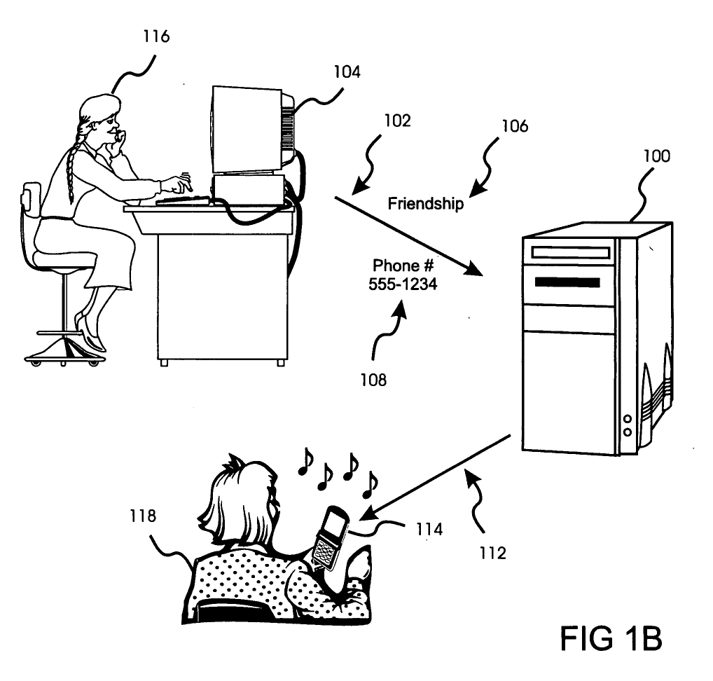

The present invention is a system for providing musical message content. In various embodiments, the system is either media containing software that is able to control a computer so as to provide musical message content, or an apparatus including a computer that is able to provide musical message content. In either case, with reference to FIG. 1, a computer 100 is able to receive a request 102 from a requesting source 104 specifying at least one thematic category 106 that should be associated with a musical recording, and further specifying an email address, a telephone number and/or other information that identifies a destination device 108 to which the musical recording should be delivered. In various embodiments, each of the requesting source 104 and the destination device 108 can be a computer, a telephone, a personal digital assistant, a smart phone, a device that is able to send text messages; and/or a device that is able to browse the internet.

Once the request 102 is received from the requesting source 104, the computer 100 communicates with a database 110, which may be located on the computer 100, or may be located on a different computing device with which the computer 100 is in communication. The database 110 contains a library of musical recordings, each of which is associated with at least one thematic category, such as “love,” “friendship,” “anniversary,” “I'm sorry,” and such like. The computer 100 obtains from the database 110 at least one musical recording associated with the specified thematic category or categories 106 and, depending on the embodiment, either chooses one of the musical recordings at random or provides a user interface than enables user selection of a musical recording. In either case, the selected musical recording 112 is then delivered to the specified receiving destination 114.

An example is presented in FIG. 1B, wherein a sending individual 116 uses a personal computer 104 to transmit over the internet a request 102 to the computer 100 of the present invention. The request 102 indicates that the sending individual 116 would like to send a musical selection thematically indicating “friendship” 106 to a specified telephone number 108, which is the cell phone number of a friend 118. The musical recording 112 is then delivered to the friend 118, and the friend 118 listens to the musical recording 112 using the designated cell phone 114.

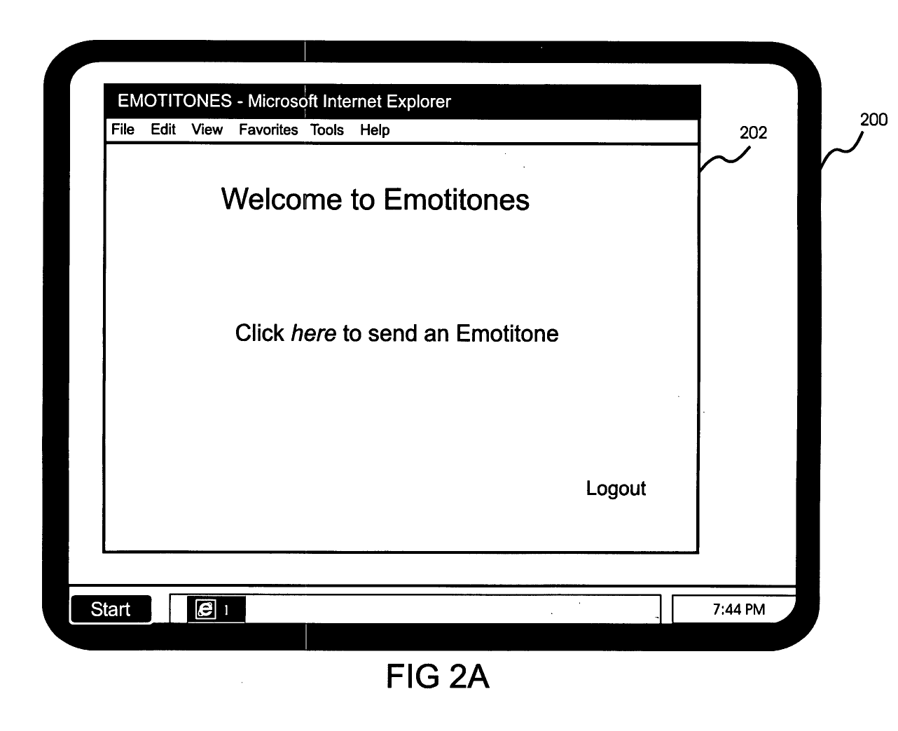

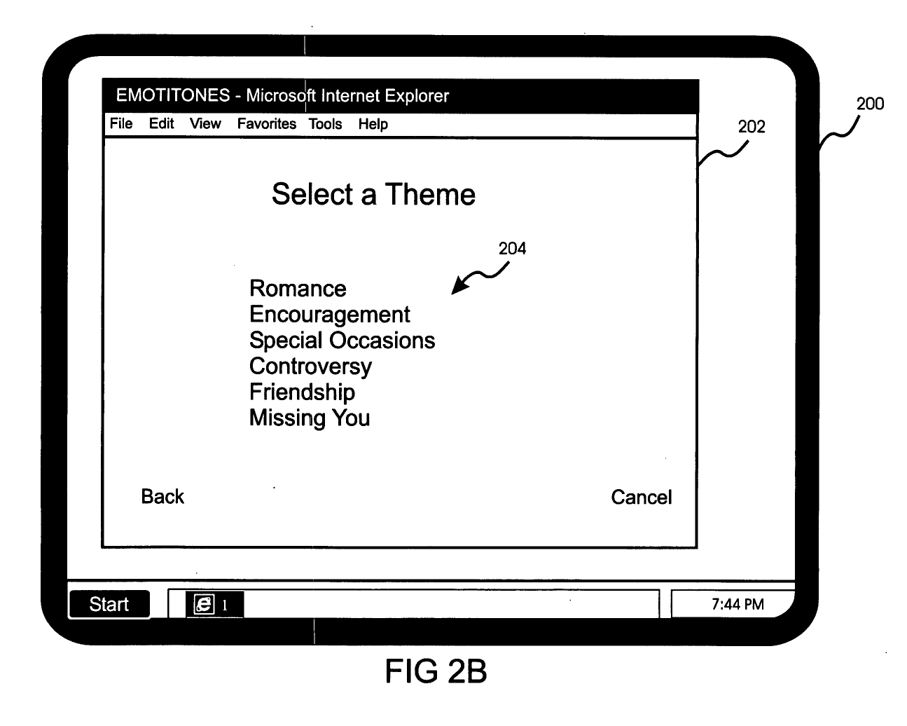

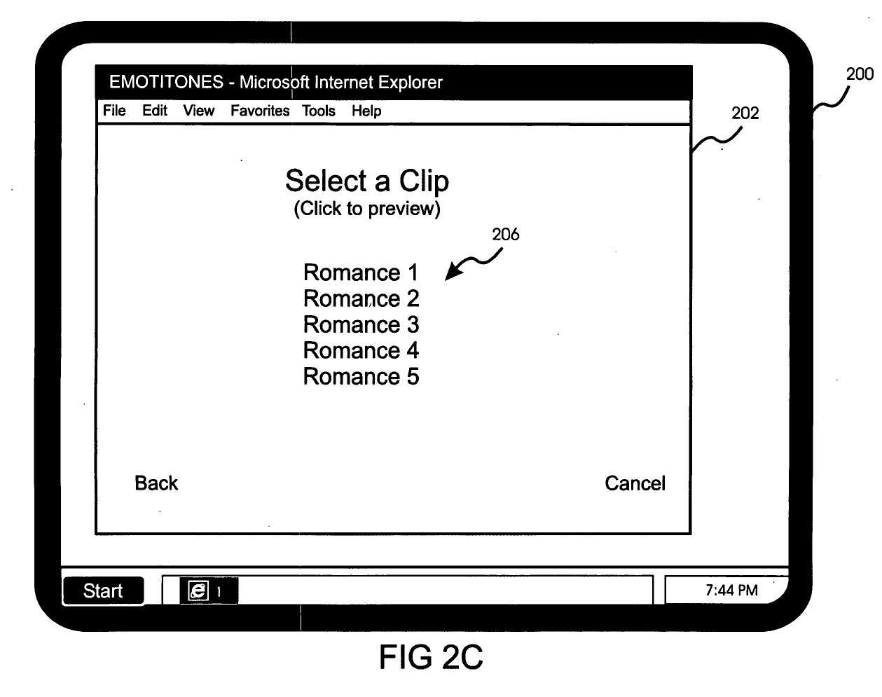

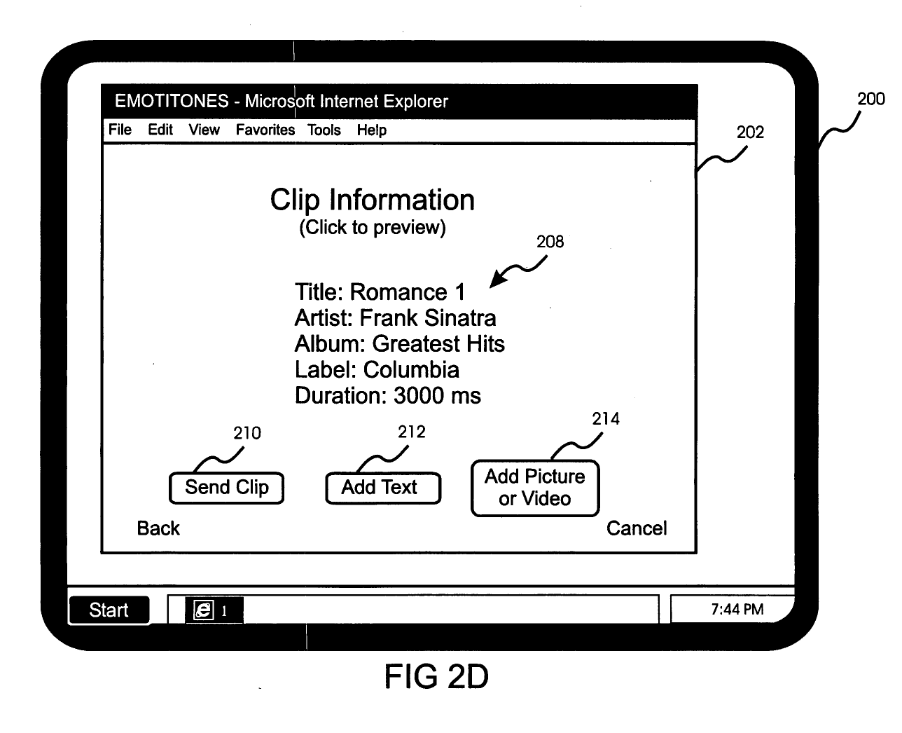

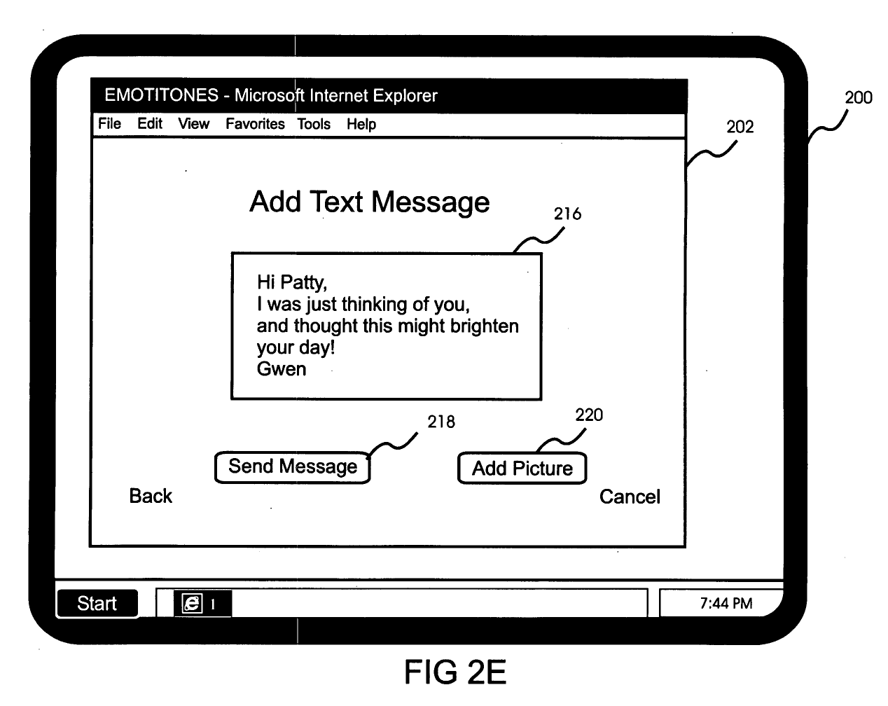

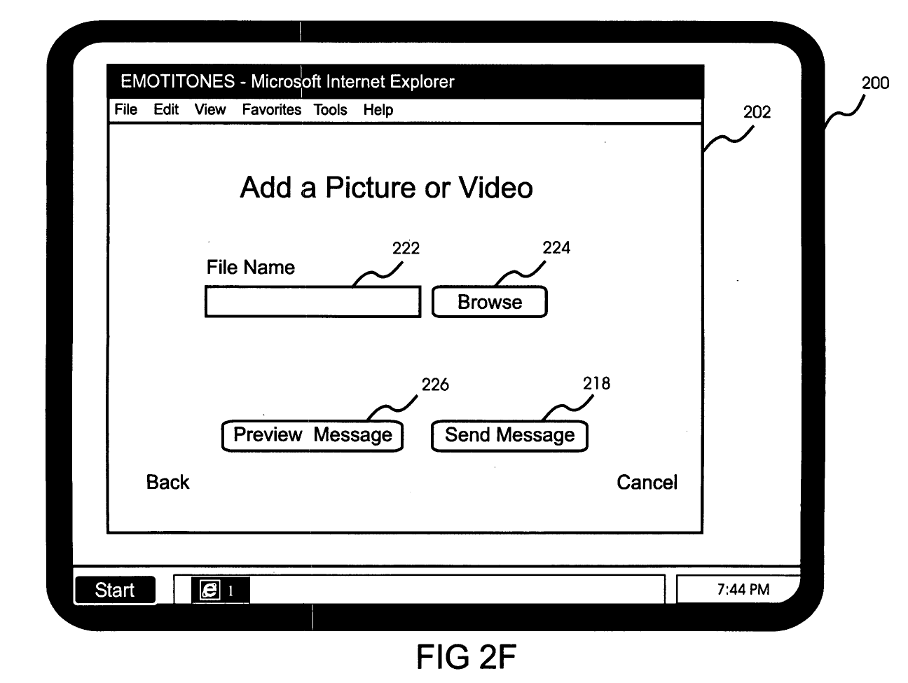

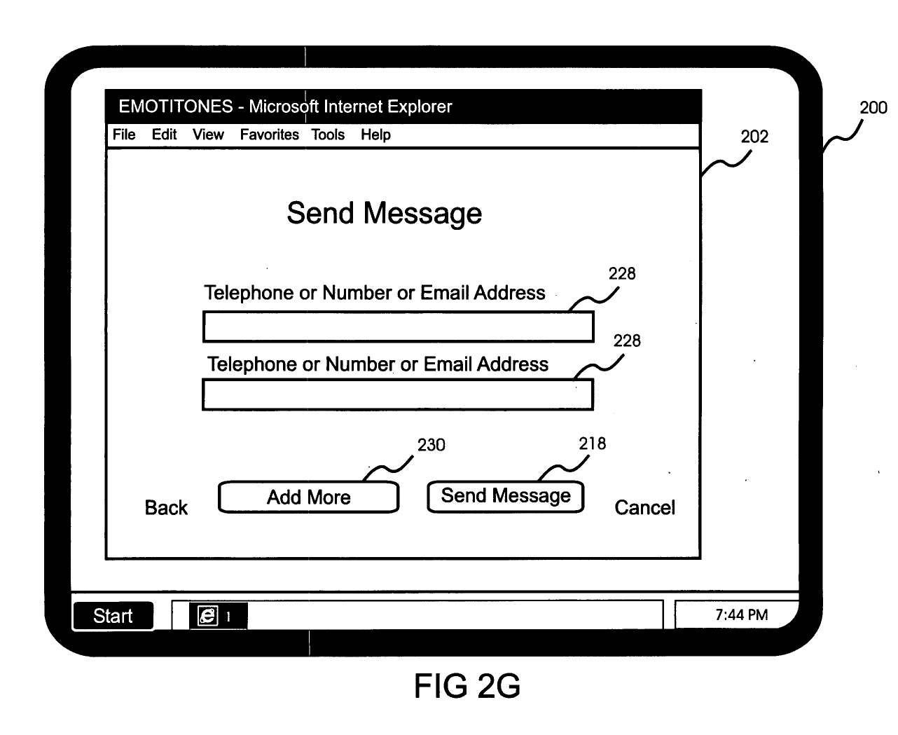

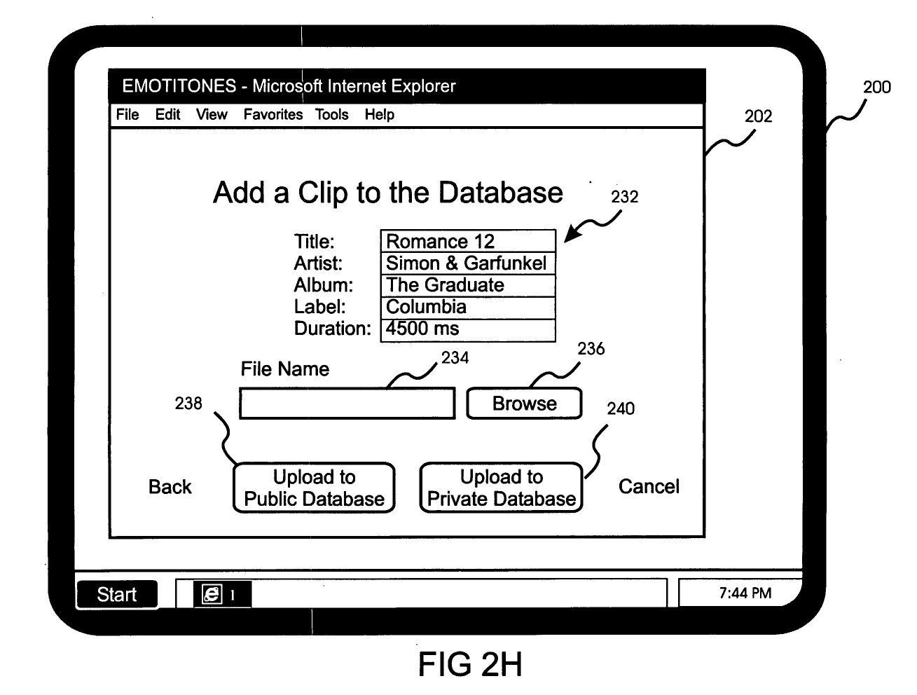

FIG. 2A through FIG. 2F illustrate computer displays 200 displaying user interface windows 202 that facilitate generation of a request in a preferred embodiment of the present invention. In FIG. 2A a user is invited to initiate the process of sending a request. In FIG. 2B, the user is invited to select a theme 204 to be communicated by a musical recording. In similar embodiments, the user is able to select more than one thematic category, so as to select a musical recording that is associated with as many of the designated thematic categories as possible. The thematic categories can relate to emotions, such as friendship, romance, and sympathy; special occasions, such as birthdays, anniversaries, and graduations; occupations, such as doctor, lawyer, and secretary; religious themes; and musical categories, such as classical, pop, and jazz.

In FIG. 2C, after selecting at least one thematic category, the user is presented with a list of sound recordings 206 that are associated with that thematic category. In FIG. 2D, one of the sound recordings has been selected, and details 208 regarding the selection are displayed. In similar embodiments, one of the sound recordings 206 associated with the theme is selected by the software at random.

In the embodiment of FIG. 2D, the user is able to send the sound recording 210 to the specified destination, or the user can choose to add text 212 or a picture 214 to accompany the sound recording, for example if the message is to be delivered as a multi-media “MMS” message to a cell phone or as an email with attached picture and sound recording.

In FIG. 2E, the user is invited to compose a text message 216 to accompany the sound recording. After entering the text message, the user can choose either to send the message 218 or to add a picture or video 220. If the user chooses to add a picture or video, the screen illustrated in FIG. 2F is displayed. The user may then either enter the file name of the picture or video 222 or browse to find the file 224. In similar embodiments, if the message is originated using a cell phone with a built-in camera, the cell phone can be used to take a picture and attach it to the message. The completed message can then be previewed 226 and sent 218.

FIG. 2G illustrates a screen that is used in a preferred embodiment to specify the recipient of the sound recording together with any accompanying message, picture, and/or video. At least one email address or telephone number is specified 228. If multiple recipients are desired, and if there is not enough space on the screen, an additional screen can be activated 230 so as to add more recipients. The message is then sent 218 to the recipients.

FIG. 2H illustrates a screen that is included in the user interface of some preferred embodiments so as to allow a user to add a sound recording to the database. Information regarding the sound recording 232 is entered, and the file name for the musical recording can be typed in 234 or found by browsing 236. In the embodiment of FIG. 2H, the user can add the sound recording either to the general database available to all users 238, or to a private library only available to the uploading user 240.

Other modifications and implementations will occur to those skilled in the art without departing from the spirit and the scope of the invention as claimed. Accordingly, the above description is not intended to limit the invention except as indicated in the following claims.

What is claimed is:

1. An article of manufacture for providing musical message content, the article of manufacture comprising:
media containing software that is able to direct the actions of a computer so as to cause the computer to:
accept a request from a requesting source, the request specifying at least one thematic category and a receiving destination, the at least one thematic category being selected from a group of selectable thematic categories;
select from a database a musical recording associated with the specified at least one thematic category, the database containing a plurality of musical recordings, each musical recording being associated with at least one of the selectable thematic categories; and
provide the selected musical recording to the specified receiving destination.

2. The article of manufacture of claim 1, wherein the requesting source is at least one of:
a computer;
a telephone;
a personal digital assistant;
a smart phone;
a device that is able to send text messages; and
a device that is able to browse the internet.

3. The article of manufacture of claim 1, wherein the receiving destination is at least one of:
a computer;
a telephone;
a personal digital assistant;
a smart phone;
a device that is able to browse the internet.

4. The article of manufacture of claim 1, wherein at least one of accepting the request and providing the musical recording includes communication using at least one of:
wired telephony;
wireless telephony;
network communication; and
communication over the internet.

5. The article of manufacture of claim 1, further comprising media containing the database containing a plurality of musical recordings associated with selectable thematic categories.

6. The article of manufacture of claim 1, wherein the software is able to cause the computer to accept input from the requesting device specifying a message to be sent to the receiving device in cooperation with the musical recording.

7. The article of manufacture of claim 6, wherein the message includes at least one of:
text;
a visual image; and
a visual animation.

8. The article of manufacture of claim 6, wherein the software is able to cause the computer to provide a user interface that can facilitate specification of the message.

9. The article of manufacture of claim 1, wherein the software is able to cause the computer to provide a user interface that can facilitate selection of the musical recording from a group of candidate musical recordings that are associated with the specified at least one thematic category.

10. The article of manufacture of claim 1, wherein, when a plurality of musical recordings in the database is associated with the at least one thematic category, the software is able to cause the computer to randomly select one musical recording from among the plurality of musical recordings, and to provide it to the specified receiving destination.

11. The article of manufacture of claim 1, wherein the group of selectable thematic categories includes a category relating to at least one of:
emotions;
relationships;
special occasions;
occupations;
religions; and
music.

12. The article of manufacture of claim 1, wherein the software is able to cause the computer to accept from a user a musical recording associated with at least one of the selectable thematic categories, and to add the accepted musical recording to the database.

13. The article of manufacture of claim 12, wherein the user can specify that the accepted musical recording added to the database will be one of:
only available for selection by the user; and
generally available for selection by all users.

14. An apparatus for providing musical message content, the apparatus comprising:
a computer having access to a database of musical recordings, each musical recording being associated with at least one of a group of selectable thematic categories, the computer being able to:
accept a request from a requesting source, the request specifying at least one thematic category and a receiving destination, the at least one thematic category being selected from the group of selectable thematic categories;
select from the database a musical recording associated with the specified at least one thematic category; and
provide the selected musical recording to the specified receiving destination.

15. The apparatus of claim 14, wherein at least one of the requesting source and the receiving destination is at least one of:
a computer;
a telephone;
a personal digital assistant;
a smart phone;
a device that is able to send text messages; and
a device that is able to browse the internet.

16. The apparatus of claim 13, wherein the computer is able to accept input from the requesting device specifying a message to be sent to the receiving device in cooperation with the musical recording.

17. The apparatus of claim 16, wherein the message includes at least one of:
text;
a visual image; and
a visual animation.

18. The apparatus of claim 13, wherein the computer is able to provide a user interface that can facilitate selection of the musical recording from a group of candidate musical recordings that are associated with the specified at least one thematic category.

19. The apparatus of claim 13, wherein the group of selectable thematic categories includes a category relating to at least one of:
emotions;
relationships;
special occasions;
occupations;
religions; and
music.

20. The apparatus of claim 13, wherein the computer is able to accept from a user a musical recording associated with at least one of the selectable thematic categories, and add the accepted musical recording to the database.
